(19) United States
(12) Patent Application Publication
(10) Pub. No.: US 2014/0087570 A1
(43) Pub. Date: Mar. 27, 2014

(54) CABLE EXIT METHODS FOR PCIE CARDS

(71) Applicant: LSI CORPORATION, Milpitas, CA (US)

(72) Inventors: Jason Stuhlsatz, Dacula, GA (US); Gregory Shogan, Round Rock, TX (US); Lakshmana Anupindi, Suwanee, GA (US); Patrick Haverty, Manteca, CA (US)

(73) Assignee: LSI CORPORATION, Milpitas, CA (US)

(21) Appl. No.: 13/624,534

(22) Filed: Sep. 21, 2012

(51) Int. Cl. H01R 12/75

(52) U.S. Cl. 439/55

(57) ABSTRACT

The present disclosure is directed to an apparatus configured for providing a plurality of exit routes to a single type of cable. The apparatus includes a board configured to have a notch. The notch is dimensioned to have a first predetermined distance from a lowest edge of the notch to a pin A1 location on the board and a second predetermined distance from an edge of the board to the pin A1 location. The apparatus also includes a plurality of connectors configured for receiving a cable of the plurality of the single type of cable. Each cable is inserted into a respective connector, and each cable exits the board through the notch. The cable may exit the board through a plurality of routes without requiring changes to the dimension of the board or placement of the connectors.

### TECHNICAL FIELD

The present disclosure generally relates to the field of Peripheral Component Interconnect Express (PCIe) cards and cable connectors, and more particularly to an apparatus for providing a plurality of exit routes to a single type of cable from a PCIe card.

### BACKGROUND

Current systems and methods for exiting a cable, such as a Serial Attached SCSI (“SAS”) cable from a PCIe card may present problems with overextending the bend radius of the SAS cable as it exits the card. If the SAS cable and PCIe card are to be implemented in a variety of ways, it may be necessary to use different cable types and card configurations to accommodate the different system implementations.

Therefore, there exists a need for improved methods and systems for configuring a PCIe card and cable connectors to accommodate different exit routes for SAS cables.

### SUMMARY

The present disclosure is directed to an apparatus configured for providing a plurality of exit routes to a single type of cable. The apparatus includes a board configured to have a notch. The notch is dimensioned to have a first predetermined distance from a lowest edge of the notch to a pin A1 location on the board and a second predetermined distance from an edge of the board to the pin A1 location. The apparatus also includes a plurality of connectors configured for receiving a cable of the plurality of the single type of cable. Each cable is inserted into a respective connector, and each cable exits the board through the notch. The cable may exit the board through a plurality of routes without requiring changes to the dimension of the board or placement of the connectors.

The present disclosure is also directed to an apparatus configured for providing a plurality of exit routes to a single type of cable. The apparatus includes a board configured for providing a plurality of exit routes to a single type of cable. The board includes a notch which is configured to have a predetermined distance from a lowest edge of the notch to a pin A1 location on the board, as well as a second predetermined distance from an edge of the board to pin A1. The apparatus also includes a connector configured for receiving the single type of cable. The single type of cable connects to the connector and exits the board through the notch of the board, and may take a plurality of exit routes without requiring changes to the board configuration or cable type.

The present disclosure is also directed to a method for connecting a plurality of cables, a plurality of connectors, and a board. The method includes the step of housing the plurality of connectors on the board. Each connector is configured to receive a cable of the plurality of cables. The method also includes the step of configuring a notch in the board. The notch is dimensioned to allow each cable to exit the board when connected to each connector. The placement of the notch and the connectors in the board allows each cable of the plurality of cables to exit the board via a plurality of routes.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 shows an apparatus configured for providing a plurality of exit routes to a single type of cable, the apparatus including four connectors;

FIG. 2 shows an apparatus configured for providing a plurality of exit routes to a single type of cable, the apparatus including two connectors; and

FIG. 3 shows an apparatus configured for providing a plurality of exit routes to a single type of cable, the apparatus including one connector;

FIG. 4 shows a flow diagram of a method for implementing a system including a plurality of cables, a plurality of connectors, and a board.

### DETAILED DESCRIPTION

Reference will now be made in detail to the subject matter disclosed, which is illustrated in the accompanying drawings.

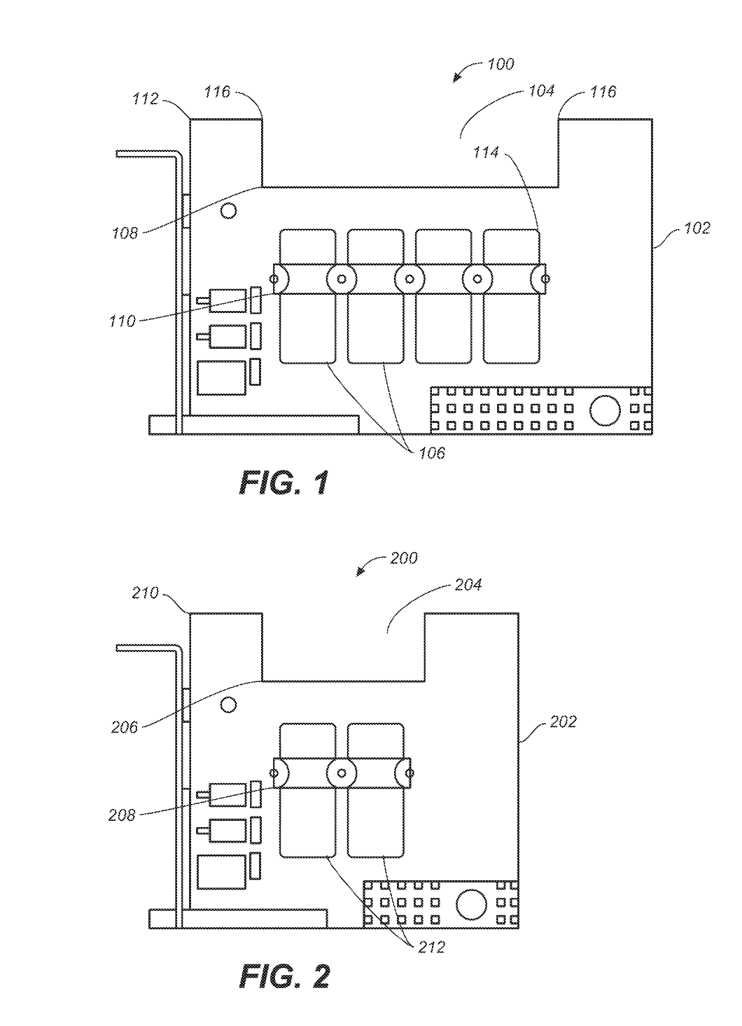

Referring generally to FIG. 1, an apparatus 100 configured for providing a plurality of exit routes to a single type of cable is shown. The apparatus 100 includes a board 102, a notch 104, and a plurality of connectors 106. The apparatus is capable of providing a plurality of exit routes to a plurality of a single type of cable without requiring changes to the apparatus 100.

The board 102 of the apparatus 100 shown in FIG. 1 may be a Peripheral Component Interconnect (PCI) or Peripheral Component Interconnect Express (PCIe) card. The board 102 includes a notch 104 which is dimensioned to facilitate the plurality of exit routes for the single type of cable without requiring changes to the dimensions of the board 102 for different exit routes. The notch 104 of the board 102 is dimensioned to have a predetermined distance from a lowest edge of the notch 108 to a pin A1 location 110.

The notch 104 is also dimensioned to have a second predetermined distance from an edge 112 of the board 102 to the pin A1 location 110. The second predetermined distance may extend up to a distance that is reasonable for proper placement of each of the plurality of connectors 106.

The apparatus 100 also includes the plurality of connectors 106. Each connector of the plurality of connectors 106 is configured for receiving the single type of cable. In one example, the connectors 106 are 12G miniSAS-HD connectors, configured for receiving 12G Serial Attached Small Computer System Interface (SCSI) cables, although it is contemplated that other connector types and cable types may also be used. For example, a 6G Serial Attached SCSI cable, or a PCIe cable may be used, as well as their corresponding connectors. The plurality of connectors 106 may include four connectors 106 in one embodiment.

The apparatus 100 is configured so that each cable is inserted into a respective connector of the plurality of connectors 106. Each cable exits the board 102 through the notch 104. The cables may exit the board 102 in several ways without requiring changes to the configuration of the apparatus 100, the dimension of the board 102, or the placement of the connectors 106. For example, the cables may exit the board 102 via a side out exit route, rear exit route, front exit route, or a straight exit route, without changing the board 102 or placement of the connectors 106.

The apparatus 100 may also be configured to provide a clearance between the plurality of connectors 106 and the notch 104. The clearance may be present on both sides of the plurality of connectors 106. The length of the notch 104 may be equal to a sum of a width of the plurality of connectors plus the clearance dimension on each side of the plurality of connectors.

In one example, the apparatus 100 shown in FIG. 1 is a Peripheral Component Interconnect Express (PCIe) card 102. The PCIe card 102 is configured for providing a plurality of exit routes to a 12G Serial Attached SCSI cable. The notch 104 is configured to have a distance of 0.758 inches from a lowest edge 108 of the notch 104 to a pin A1 location 110. The notch 104 is also configured to have a distance of 1.246 inches from an edge 116 of the PCIe card 102 to the pin A1 location 110.

The apparatus 100 shown in FIG. 1 may include four 12G miniSAS-HD connectors 106 in this example. Each of the four 12G miniSAS-HD connectors 106 is configured to receive a 12G Serial Attached SCSI cable. In the example, the distance between the edge 114 of the plurality of connectors and the edge of the notch 116 is 0.071 inches. This distance may range up to 0.09 inches in an alternative embodiment.

A 12G Serial Attached SCSI cable is inserted into each of the four 12G miniSAS-HD connectors 106, and each 12G Serial Attached SCSI cable exits the PCIe card 102 through the notch 104. The use of the apparatus 100 facilitates the exit of the 12G Serial Attached SCSI cable from the PCIe card 102 via any one of a plurality of exit routes. The exit route may include a side out exit route, rear exit route, front exit route, and a straight exit route.

Referring generally to FIG. 2, an embodiment of the apparatus 200 is provided which includes two connectors 212. The apparatus 200 includes a board 202, which includes a notch 204 which is dimensioned to facilitate the plurality of exit routes for the single type of cable without requiring changes to the dimensions of the board 202 for different exit routes. The notch 204 of the board 202 is dimensioned to have a predetermined distance from a lowest edge 206 of the notch 206 to a pin A1 location 208. This predetermined distance may range from 0.758 inches up to 0.760 inches. In one embodiment, this predetermined distance is 0.758 inches. The notch 204 is also configured to have a second predetermined distance from an edge 210 of the PCIe card 202 to the pin A1 location 208. In one example, this distance may be 1.246 inches.

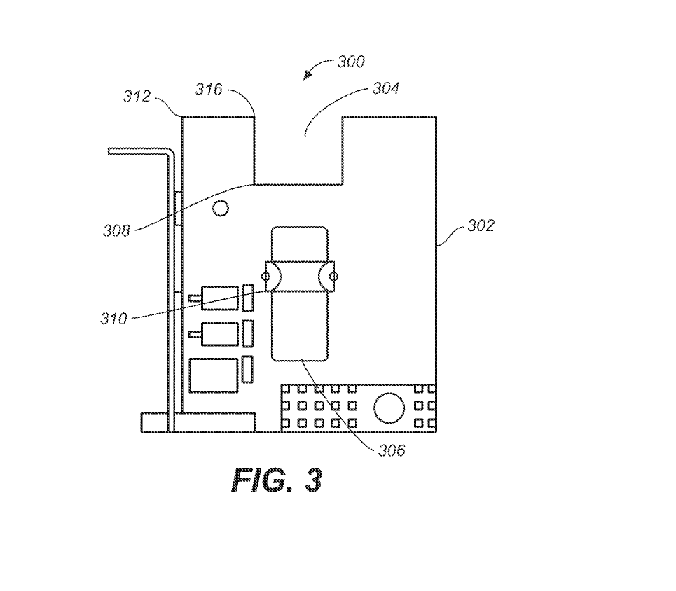

Referring generally to FIG. 3, an embodiment of an apparatus 300 configured for providing a plurality of exit routes to a single type of cable is shown. The apparatus 300 includes a board 302, a notch 304, and a single connector 306. The apparatus 300 is capable of providing a plurality of exit routes to a single type of cable without requiring changes to the apparatus 300.

The board 302 includes a notch 304 which is dimensioned to facilitate the plurality of exit routes for the single type of cable without requiring changes to the dimensions of the board 302 for different exit routes or a change in cable type to accommodate a different exit route. The notch 304 of the board 302 is dimensioned to have a predetermined distance from a lowest edge of the notch 308 to a pin A1 location 310. This predetermined distance may range from 0.758 inches up to 0.760 inches in one example.

The notch 304 is also dimensioned to have a second predetermined distance from an edge 312 of the board 102 to the pin A1 location 310. The second predetermined distance may extend up to a distance that is reasonable for proper placement of the connector 306. In one embodiment, the second predetermined distance may range from 1.246 inches up to 1.250 inches. In one embodiment, the second predetermined distance is 1.246 inches.

The apparatus 300 is configured so that the cable is inserted into the connector 306 and exits the board 302 through the notch 304. The cable may exit the board 302 in several ways without requiring changes to the configuration of the apparatus 300, the dimension of the board 302, or the placement of the connector 306.

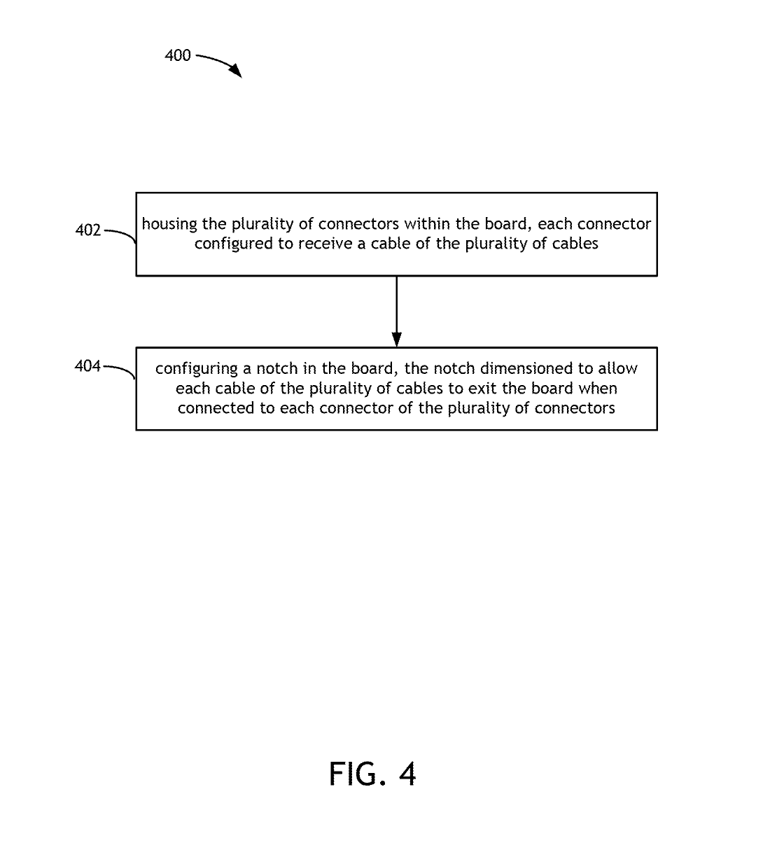

The present disclosure is also directed to the method 400 shown in FIG. 4. The method 400 can be used for connecting a plurality of cables, a plurality of connectors, and a board. The method 400 includes the step of housing the plurality of connectors within the board 402. Each connector of the plurality of connectors is configured to receive a cable of the plurality of cables. The next step of the method 400 is to configure a notch in the board 404. The notch is dimensioned to allow each cable of the plurality of cables to exit the board when connected to each connector of the plurality of connectors. The placement of the notch and the connectors in the board allows each cable of the plurality of cables to exit the board via a plurality of routes. The plurality of exit routes may include a side out exit route, rear exit route, front exit route, and a straight exit route.

The step of configuring a notch in the board 402 of the method 400 may include configuring the notch to have a predetermined distance from a lowest edge of the notch to a pin A1 location equal to approximately 0.758 inches, and configuring the notch to have a second predetermined distance from an edge of the board to a pin A1 location equal to approximately 0.488 inches.

The method 400 can be used for connecting a plurality of cables, a plurality of connectors, and a board. The board may include a Peripheral Component Interconnect Express card, and the plurality of cables may include a plurality of a single type of 12G Serial Attached SCSI cables. The plurality of connectors may include a plurality of 12G miniSAS-HD connectors. In one embodiment, the method and apparatus are configured to provide a configuration that is compliant with a connector standard for a miniSAS-HD connector, such as the SFF-8643 standard.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed is:

1. An apparatus, comprising:
a board, the board configured for providing a plurality of exit routes to a single type of cable, the board including a notch, the notch having a predetermined distance from a lowest edge of the notch to a pin A1 location on the board, the notch having a second predetermined distance from an edge of the board to pin A1;
a connector, the connector configured for receiving the single type of cable;
wherein the single type of cable connects to the connector and exits the board through the notch of the board.

2. The apparatus as claimed in claim 1, wherein the predetermined distance from the lowest edge of the notch to the pin A1 location is 0.758 inches.

3. The apparatus as claimed in claim 1, wherein the second predetermined distance from an edge of the board to pin A1 is 0.488 inches.

4. The apparatus as claimed in claim 1, wherein the length of the notch is equal to the width of the connector plus a clearance dimension on each side of the width of the connector.

5. The apparatus as claimed in claim 1, further comprising a second connector, the second connector configured for receiving a cable of the single type of cable.

6. The apparatus as claimed in claim 1, wherein the board is a Peripheral Component Interconnect Express card.

7. The apparatus as claimed in claim 1, wherein the single type of cable is one of: a 12G Serial Attached SCSI cable, a 6G Serial Attached SCSI cable, or a PCIe cable.

8. The apparatus as claimed in claim 1, wherein the connector is a 12G miniSAS-HD connector.

9. The apparatus as claimed in claim 1, wherein the plurality of exit routes includes a side out exit route, rear exit route, front exit route, and a straight exit route.

10. An apparatus, comprising:
a board, the board configured for providing a plurality of exit routes to a single type of cable, the board including a notch, the notch having a predetermined distance from a lowest edge of the notch to a pin A1 location on the board, the notch having a second predetermined distance from an edge of the board to pin A1;
a plurality of connectors, each connector of the plurality of connectors configured for receiving a cable of the single type of cable;
wherein each cable of the single type of cable connects to each connector of the plurality of connectors and exits the board through the notch of the board.

11. The apparatus as claimed in claim 10, wherein the predetermined distance from the lowest edge of the notch to the pin A1 location is 0.758 inches.

12. The apparatus as claimed in claim 10, wherein the second predetermined distance from an edge of the board to pin A1 is 0.488 inches.

13. The apparatus as claimed in claim 10, wherein the length of the notch is equal to a sum of a width of the plurality of connectors plus a clearance dimension on each side of the width of the plurality of connectors.

14. The apparatus as claimed in claim 10, wherein the board is a Peripheral Component Interconnect Express card.

15. The apparatus as claimed in claim 10, wherein the single type of cable is one of: a 12G Serial Attached SCSI cable, a 6G Serial Attached SCSI cable, or a PCIe cable.

16. The apparatus as claimed in claim 10, wherein the plurality of exit routes includes a side out exit route, rear exit route, front exit route, and a straight exit route.

17. A method for connecting a plurality of a single type of cable, a plurality of connectors, and a board, the method comprising:
housing the plurality of connectors on the board, each connector configured to receive a cable of the plurality of cables;
configuring a notch in the board, the notch dimensioned to allow each cable of the plurality of a single type of cable to exit the board when connected to each connector of the plurality of connectors;
wherein the placement of the notch and the connectors in the board allows each cable of the plurality of the single type of cable to exit the board via a plurality of routes.

18. The method of claim 17, wherein the configuring a notch in the board includes configuring the notch to have a predetermined distance from a lowest edge of the notch to a pin A1 location equal to approximately 0.758 inches.

19. The method of claim 17, wherein the configuring a notch in the board includes configuring the notch to have a second predetermined distance from an edge of the board to a pin A1 location equal to approximately 0.488 inches.

20. The method of claim 17, wherein the plurality of exit routes includes a side out exit route, rear exit route, front exit route, and a straight exit route.
